(19) United States
(12) Patent Application Publication
(10) Pub. No.: US 2010/0156907 A1
(43) Pub. Date: Jun. 24, 2010

(54) DISPLAY SURFACE TRACKING

(75) Inventors: Paul J. VanderSpek, Redwood City, CA (US); Charbel Khawand, Redmond, WA (US); Peter Mikolajczyk, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/342,806

(22) Filed: Dec. 23, 2008

(51) Int. Cl. G06T 15/20; G09G 5/00

(52) U.S. Cl. 345/427; 345/156

(57) ABSTRACT

Display surface tracking techniques are described in which a one or more modules may perform enhanced rendering techniques to output graphics based on tracking of a display device. In an embodiment, one or more tracking sensors may be used to track position of a display relative to a viewer. In at least some embodiments, the tracking sensors include a camera of the device that is used to monitor a position of the viewer relative to the display. Based on tracking performed via the one or more tracking sensors, projection planes used to render graphics on the display may be calculated and a graphics presentation may be output in accordance with the calculated projection planes.

### BACKGROUND

The popularity of mobile devices, such as mobile phones, audio players, media players, and so forth is ever increasing. As the popularity of mobile devices has increased, competition for purchasers of the devices has also increased. This competition has led mobile device retailers and manufacturers to seek devices that provide more and more marketable features. Often, a consumer may make a purchase decision based at least in part upon the richness of features offered by the device. Thus, success of a mobile device in the marketplace may depend in part upon delighting consumers with marketable features that create an enhanced user experience.

### SUMMARY

Display surface tracking techniques are described in which a one or more modules may perform enhanced rendering techniques to output graphics based on tracking of a display device. In an embodiment, one or more tracking sensors may be used to track position of a display relative to a viewer. In at least some embodiments, the tracking sensors include a camera of the device that is used to monitor a position of the viewer relative to the display. Based on tracking performed via the one or more tracking sensors, projection planes used to render graphics on the display may be calculated and a graphics presentation may be output in accordance with the calculated projection planes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example environment that is operable to employ display surface tracking techniques.

FIG. 2 is a flow diagram depicting an example procedure in accordance with one or more embodiments.

FIG. 3A and FIG. 3B provide illustrations depicting example display surface tracking scenarios in accordance with one or more embodiments.

FIG. 4 is a flow diagram depicting an example procedure in accordance with one or more embodiments.

### DETAILED DESCRIPTION

### Overview

Consumers continue to demand mobile devices having new and improved features. The “wow” factor associated with a mobile device may play an important role in determining whether a consumer will choose to buy the device. Accordingly, manufacturers and retailers may seek unique and advanced device features to boost the “wow” factor and compete for consumer dollars.

Display surface tracking techniques are described which enable presentation of realistic three-dimensional (3D) graphics and effects on a mobile device. This may involve tracking position of a display device in relation to a viewer and adjusting graphic presentations accordingly to enhance the perception of 3D space on a two-dimensional (2D) display. Such 3D graphic capabilities may contribute to the “wow” factor of a device that includes these capabilities.

In order to perform display surface tracking, one or more tracking sensors may be used to track position of a display of a mobile device in relation to a viewer. Based on the tracking data from the tracking sensors, changes in projection angles at which graphics are rendered may be determined. These projection angles may define a projection plane (e.g., the drawing perspective) used to render the graphics for display. A graphics presentation may be output in accordance with a projection plane that is calculated based on changes to one or more projection angles. In at least some embodiments, the tracking sensors include a camera of the device that may be used to track a viewer's face position relative to the device.

By way of example, consider a 3D image or effect that is presented via a display device, such as a hand that is rendered in 3D. A variety of 3D techniques may be employed to produce the image examples including stereoscopic filming, polarization, a digital 3D format, or other suitable 3D techniques. In this example, the hand may be rendered so that it appears to protrude from the display device and grab directly at the viewer. Without display surface tracking techniques, a viewer that is not positioned directly in front of the display may be unable to see the grabbing effect, may see just part of the effect, or may see the hand grabbing away from them. In this scenario, the viewer would not experience the 3D grabbing effect as intended.

Accordingly, the example grabbing effect may be adjusted based on tracking data from the tracking sensors. Specifically, a projection plane used for the grabbing effect may be determined based upon a position of the viewer in relation to the display. The projection plane and rendered graphics may be adjusted to maintain approximately the same perspective regardless of the viewer's position. In this manner, the 3D effect may be rendered to appear substantially the same to the viewer at each position.

In another example, consider a 3D animation of a cartoon bunny. Initially, an image of the bunny may be rendered on a mobile device to show the front side of the bunny, its face and buckteeth fully visible. Now, when a viewer rotates the mobile device ninety degrees, tracking sensors of the device may detect this change, a new projection plane may be determined, and a side view of the cartoon bunny may be rendered in response. A further ninety degree rotation of the mobile device by the viewer and the bunny's characteristic cotton tail may be revealed in a rear view rendering. In this manner, the 3D cartoon bunny responds realistically to relative position changes of the device, as though the viewer was holding and moving the bunny rather than the device.

In the following discussion, an example environment is first described that is operable to perform display surface tracking techniques. Example procedures are then described that may be employed in the example environment, as well as in other environments. Although these techniques are described as employed within a computing environment in the following discussion, it should be readily apparent that these techniques may be incorporated within a variety of environments without departing from the spirit and scope thereof.

Example Environment

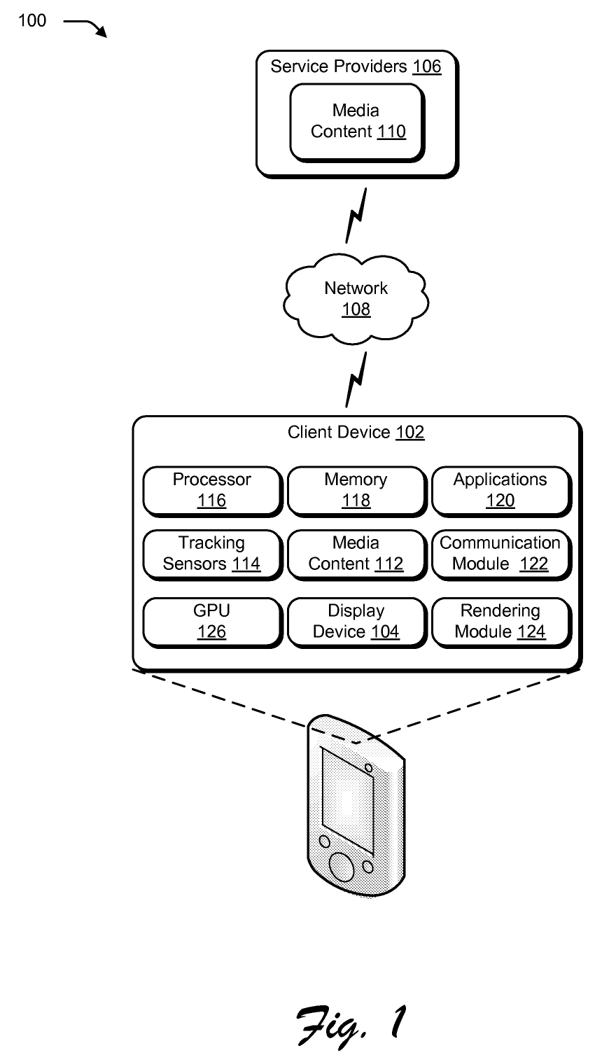

FIG. 1 depicts an example environment 100 operable to employ display surface tracking techniques described herein. The environment 100 includes a client device 102 having a display device 104. Client device 102 is illustrated as connected to one or more service providers 106 via a network 108. The network 108 represents one or more networks through which service providers 106 may be accessible including an intranet, the Internet, a broadcast network, a wireless network, a satellite network, and so forth. In the following discussion a referenced component, such as client device 102, may refer to one or more entities. Therefore, by convention, reference may be made to a single entity (e.g., the client device 102) or multiple entities (e.g., the client devices 102, the plurality of client devices 102, and so on) using the same reference number.

Client device 102 may be configured in a variety of ways. For example, client device 102 may be configured as a computer that is capable of communicating over the network 108, such as a desktop computer, a mobile station, an entertainment appliance, a set-top box communicatively coupled to a display device, and so forth. Client device 102 may also represent a mobile client device such as a hand held computing device as illustrated, a mobile phone, a personal digital assistant (PDA), or a multimedia device, to name a few. Such mobile client devices often are used with a single viewer and these devices may be manually manipulated by the viewer in various ways. These characteristics make mobile client devices well-suited to the display surface tracking techniques described herein, although the techniques are also applicable to non-mobile devices.

Client device 102 may interact via the network 108 to select and receive media content 110 available from the content sources 106. Media content 110 provided by the content sources 106 may be accessed by the client device 102 for streaming playback, storage on the client device 102, and so forth. For example, client device 102 is depicted as having media content 112 which may include media content 110 obtained from a service provider 106.

Media content 112 may also be obtained locally by the client device 102, such as through storage at the client 102 and/or provided to the client 102 on various computer-readable media. A variety of computer-readable media to store media content 112 is contemplated including floppy disk, optical disks such as compact discs (CDs) and digital video disks (DVDs), a hard disk, and so forth. Media content 110, 112 may represent different types of content, including video programs, television programs, graphics presentations, music, applications, games, internet pages, streaming video and audio, and so forth.

Client device 102 also includes one or more tracking sensors 114. The tracking sensors 114 represent different types of sensors that may be employed, alone or in combinations, to track manipulation of the client device 102. For instance, the tracking sensors 114 may be used to track a surface of the display device 104 relative to a viewer. Specifically, the tracking sensors 114 may track the surface in three-dimensions (3D) as the viewer manually manipulates the client device 102. This display surface tracking enables rendering of realistic 3D graphics based on the movement of the client device 102. The tracking sensors 114 may be configured in a variety of ways to perform display surface tracking. Examples of tracking sensors 114 suitable to perform display surface tracking include a camera, a gyroscope, a distance sensor, and an accelerometer, to name a few.

Client device 102 also includes a processor 116, memory 118, and applications 120 which may be stored in the memory 118 and executed via the processor 116. Some examples of applications 120 include an operating system, utility software, a browser application, office productivity programs, game programs, media management software, a media playback application, and so forth.

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Additionally, although a single memory 118 is shown for the client device 102, a wide variety of types and combinations of computer-readable memories may be employed including volatile and non-volatile memory and/or storage media. For example, computer-readable memories/media may include but are not limited to random access memory (RAM), hard disk memory, read only memory (ROM), flash memory, video memory, removable medium memory, and other types of computer-readable memories/media that are typically associated with a computing device 102 to store data, executable instructions, and the like.

In the depicted example, client device 102 also includes a communication module 122 and a rendering module 124. Communication module 122 represents functionality to interact with service providers 106 via the network 108. In particular, the communication module 122 may represent functionality to search, obtain, process, manage and initiate output of media content 110 and/or other resources (e.g., email service, mobile phone service, and search service, to name a few) that may be available from the service providers 106.

Rendering module 124 represents functionality to process media content 112 at the client device 102, such as to display media content 112 on the display device 104. In particular, rendering module 124 may be executed to render graphic presentations on the display device 104. These graphics presentations may include 3D graphics that take advantage of display surface tracking techniques described herein. For example, rendering module 124 may operate or otherwise make use of tracking sensors 114 to cause display surface tracking. With input obtained from the tracking sensors 114, the rendering module 124 may output graphics based on the tracking.

Rendering module 124 may be implemented as a component of operating system software. In another example, rendering module 124 may be implemented as a component of an application 120 configured as a media playback application to manage and control playback of media content 112 on the client device 102. Rendering module 124 may also be a stand-alone application that operates in conjunction with the operating system and/or a media playback application to output media content 112 for display on the display device 104. A variety of applications 120 of a client device 102 may interact with and utilize the features of the rendering module 124 to output media content 112, graphic presentations, and so forth.

Client device 102 may also include a graphics processing unit (GPU) 126 that represents functionality of the client device 102 dedicated to graphics processing. Functionality provided by the GPU 126 may include controlling aspects of resolution, pixel shading operations, color depth, texture mapping, 3D rendering, and other tasks associated with rendering images such as bitmap transfers and painting, window resizing and repositioning, line drawing, font scaling, polygon drawing, and so on. The GPU 126 may be capable of handling these processing tasks in hardware at greater speeds than the software executed on the processor 116. Thus, the dedicated processing capability of the GPU 126 may reduce the workload of the processor 116 and free up system resources for other tasks. In an implementation, GPU 126 may be operated under the influence of the rendering module 124 to perform the various processing functions For instance, rendering module 124 may be configured to provide instructions to direct the operation of the GPU 126, including processing tasks involved in techniques for display surface tracking and rendering of corresponding 3D graphics.

Generally, the functions described herein may be implemented using software, firmware, hardware (e.g., fixed-logic circuitry), manual processing, or a combination of these implementations. The terms “module”, “functionality”, “engine” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code may be stored in one or more computer-readable memory devices. The features of the techniques to provide display surface tracking are platform independent, meaning that the techniques may be implemented on a variety of commercial computing platforms having a variety of processors.

Example Procedures

The following discussion describes techniques related to display surface tracking that may be implemented utilizing the previously described environment, systems, and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the example environment 100 of FIG. 1.

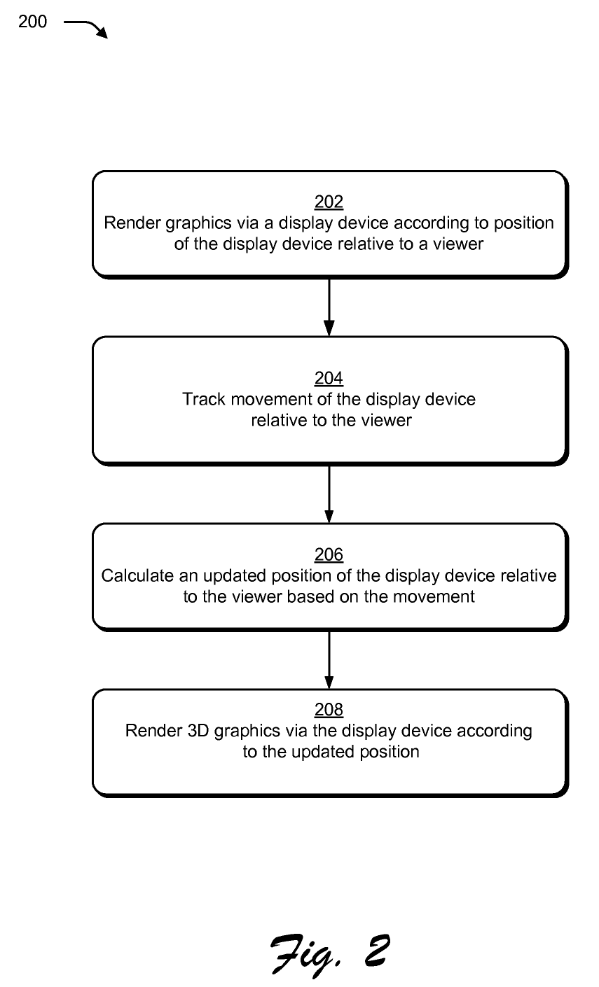

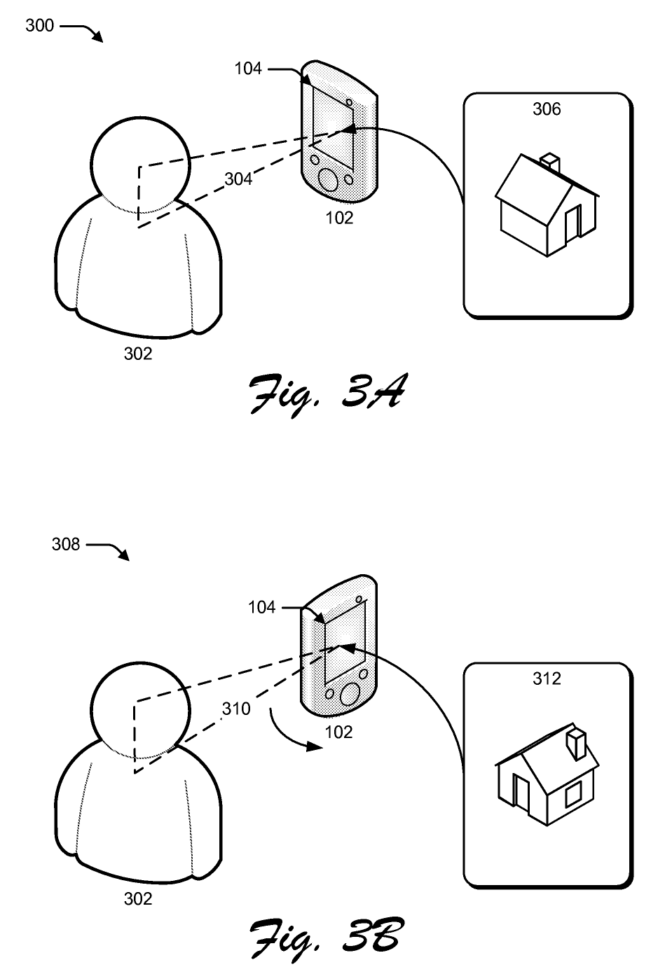

Referring to FIG. 2, an example procedure 200 is depicted in which display surface tracking is employed to present graphics. In the discussion of FIG. 2 that follows, reference may be made to the display surface tracking examples depicted in FIGS. 3A and 3B.

Graphics are rendered via a display device based upon a position of the display device relative to a viewer (block 202). For example, the rendering module 124 of FIG. 1 may cause output of a graphics presentation via the display device 104. Display device 104 may be provided a component of a client device 102 that is configured as a mobile device. In at least some embodiments, the graphics presentation may include 3D graphics, such as stereoscopic images, films, games, videos, and the like. 3D graphics may also include objects rendered in a virtual 3D environment as is done in some video games. A variety of 3D techniques may be employed to produce 3D graphics including stereoscopic filming, polarization, digital 3D format, or other suitable 3D techniques. Rendering module 124 is configured to output the graphics based upon a position of the display device 104 relative to the viewer.

One way this may occur is by adjusting a projection plane and/or associated projection angles for the rendering according to relative changes in position of the display device 104. Note that tracking sensors 114 may be employed to track position of the display device 104 in 3D, e.g., along each of a horizontal (x), a vertical (y), and a rotational (z) axis. Accordingly, the projection plane and projection angles may be defined and adjusted vertically, horizontally, and rotationally. The position may also include a distance between the viewer and the display device 104.

To begin with, a 3D graphic may be output according to initial projection angles and a corresponding projection plane that is defined by the angles. The projection plane for 3D graphics determines which surfaces of the 3D graphics are visible in a rendering on the display device 104, e.g., the perspective and/or orientation of the image for the rendering. For example, default values for the projection angles may be initially set. In this example, the initial position of the viewer (e.g., a default position) may be inferred to be directly in front of the display device. Alternatively, tracking sensors 114 may be employed to determine an initial position of the viewer and initial values for the projection angles. Then, a projection plane for rendering graphics may be determined accordingly.

Referring now to FIG. 3A, an example display surface tracking scenario is depicted, generally at 300. In this example, a viewer 302 is depicted as interacting with a client device 102 having a display device 104. An angle 304 between the viewer and the display device 104 is established. Specifically, the angle 304 may be a projection angle that is based upon the relative position of the display device 104 to the viewer 302. In accordance with display surface tracking techniques described herein, the angle 304 may be used to determine a projection plane for rendering a 3D image via the client device 102.

In the example of FIG. 3A, a house image 306 is depicted as being rendered via the client device 102. Note that the client device 102 is depicted as being rotated slightly to the left. In this arrangement, the house image 306 is rendered as a left side view. Subsequent manipulation of the client device 102, such as through manual manipulation by the viewer 302, may cause a responsive change in the depicted house image 306 to show a different view. This creates a realistic 3D appearance in which the house image may act like a physical object that the viewer 302 is holding and moving.

In another example, the viewer's perspective of the house may be maintained at each viewer position. In other words, a 3D image may be rendered so that the appearance to the viewer remains substantially the same irrespective of the viewing angle. Consider a 3D effect in which snow appears to slide off the roof of the house image 306 and protrude out of the display towards the viewer. Display surface tracking may enable rendering of this snow effect to appear approximately the same to a viewer at the angle 304 or another angle.

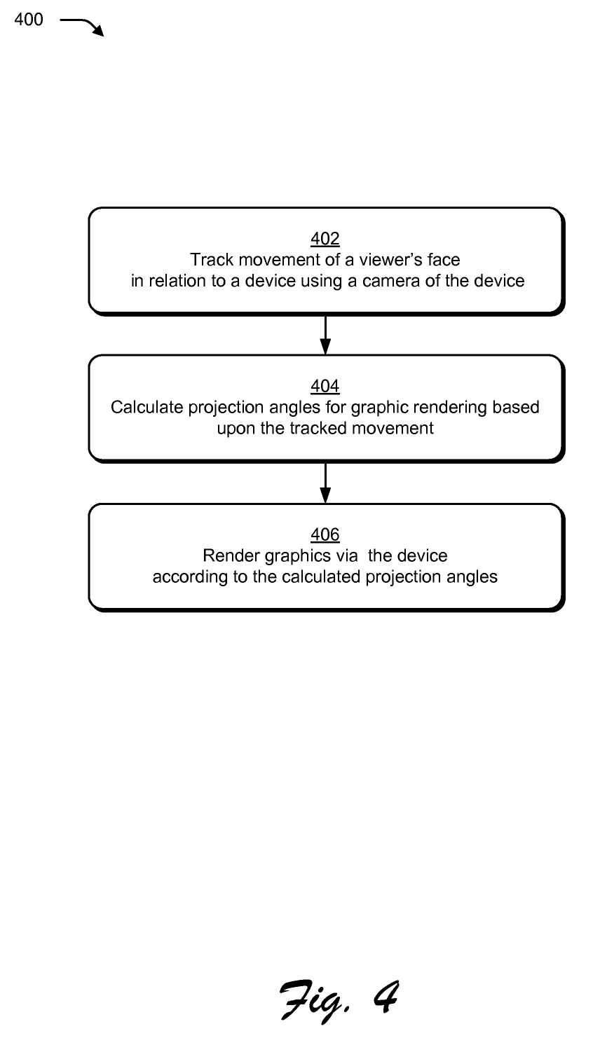

To create these 3D appearances, movement of the display device is tracked relative to a viewer (block 204). As noted the display surface tracking may occur by way of one or more tracking sensors 114. For example, a distance sensor may be used to monitor distance between the viewer and the device. In one embodiment, changes in distance detected by way of a distance sensor may be configured to cause a corresponding zooming effect on a rendered image (e.g., zooming in and out). A gyroscope may be employed to monitor orientation of the display device 104. In another example, an accelerometer may provide changes in direction, velocity, and orientation. In yet another example, a camera is provided that may be used to detect and monitor a viewer's position with respect to the display device 104. For instance, the camera may detect when the viewer moves to the left or right. The camera may be used in a preview-hidden mode (e.g., the camera image is hidden rather than rendered on the display device 104) so that the activities of the viewer are not interrupted. Further discussion of embodiments in which a tracking sensor 114 configured as a camera is employed may be found in relation to FIG. 4 below.

Data regarding position of the display device 104 that is obtained via the tracking sensors 114 may be compiled, combined, and processed by the rendering module 124. This enables rendering module 124 to determine movement of the display device 104 relative to the viewer. This movement may be determined as a difference between the tracked position and the initial or default position. The movement may also be expressed as a difference between successive tracked positions of the display device 104.

Note that display surface tracking features of a client device 102 may be selectively turned on and off. For example, rendering module 124 may be configured to include a viewer selectable option to toggle display surface tracking features on and off. A viewer may use this option to conserve power (e.g., extend battery life) for a mobile device. The viewer may also use this option to turn display surface tracking on and off as they like for various reasons.

In another example, rendering module 124 may be configured to automatically adjust or toggle display surface tracking in some situations. For example, when little movement of a viewer and/or a client device 102 is detected, display surface tracking may be adjusted to conserve battery life and/or processing power. This may involve cause tracking sensors 114 to shutdown or enter a sleep mode, changing an interval at which data is collected, turning off tracking, and/or otherwise adjusting how tracking is performed. Such adjustments may also occur automatically in response to detection of a low power situation (e.g., low battery power) and/or in response to input from a viewer.

When a relative change in position is tracked, an updated position of the display device relative to the viewer is calculated based on the movement (block 206). Then, 3D graphics are rendered via the display device according to the updated position (block 208). For example, the rendering module 124 may determine the updated position using data that is obtained from tracking sensors 114 as in the preceding example. This may occur by monitoring and detecting manipulation of the client device 102, by a viewer or otherwise, using the tracking sensors 114. Objects appearing on the display device 104 may be rendered to respond to manipulation of the client device 102. In particular, the display surface tracking techniques may be used to render realistic 3D graphics on a display device 104. In an embodiment, a projection plane for graphics rendering is adjusted as the position of the display device 104 changes in relation to the viewer.

Consider now the example of FIG. 3B in conjunction with FIG. 3A discussed above. FIG. 3B shows, generally at 308, the client device 102 of FIG. 3A after a rotation of the client device 102 from left to right. Now, the client device 102 is rotated slightly to the right. A new angle 310 is established between the viewer 302 and the display device 104. This change in position of the client device 102 between FIGS. 3A and 3B may result in a responsive change to rendered graphics. In this example, perhaps the viewer 302 rotated the client device 102 to observe and enjoy the 3D response of the house image 306 that is depicted in FIG. 3A. Specifically, in the arrangement of FIG. 3B, an updated house image 312 is rendered in which the right side of the house is now visible.

Note again, that a relative change in position between a viewer and a display device 104 may also be used to maintain the same perspective at each position. For instance, the snow effect of the preceding example may be rendered to appear the same at both the angle 304 in FIG. 3A and at the angle 310 in FIG. 3B. In this example, the left side view of the house that is depicted in FIG. 3A may appear for both the house image 306 and the updated house image 312. However, the projection plane and graphics rendered may be adjusted by the rendering module 124 according to the relative position change, such that the viewer 302 of the snow effect is able to see a similar effect at each position.

Naturally, display surface tracking techniques may be employed to adjust graphic presentations in various different ways in response to manipulation of a client device 102. For example, when a client device 102 is rotated ninety degrees upwards, a presentation of a scene may change from a front view of the scene to a bottom view of the scene. In another example, complete rotation of a client device 102 may cause a displayed object to appear to rotate around responsively. In this manner, the two-dimensional (2D) display device 104 of a client device 102 may be employed to present 3D graphics that respond realistically to manipulation of the client device 102.

Such realistic depictions of 3D graphics may be employed to enhance user experience in a variety of contexts. For instance, games may be created to take advantage of display surface tracking techniques and corresponding 3D graphics. These games may use tracking sensors 114 to obtain input during game-play and to render graphics accordingly. Advertisers may also take advantage of the described techniques to enable 3D graphics. In this context, display surface tracking techniques may enable a unique way of presenting and interacting with a three hundred and sixty degree image of an advertised product. A variety of other examples are also contemplated including using display surface tracking techniques to enhance 3D animations, application user interfaces, and playback of media content 112, to name a few.

FIG. 4 depicts a procedure 400 in an example implementation in which a tracking sensor configured as a camera is used to implement aspects of display surface tracking. Movement of a viewer's face is tracked relative to a device using a camera of the device (block 402). For example the rendering module 124 of FIG. 1 may be executed to playback media content 112 on the client device 102, such as on the display device 104. The client device 102 may be configured with one or more tracking sensors 114 including a camera. The camera may be used to determine an initial position of a viewer in relation to the client device 102. Specifically, the camera may detect the position of a viewer's face in relation to the display device 104.

One way this may occur is by having the user actively center their face relative to the display device 104 and capturing the face image. For instance, rendering module 124 may output a prompt to cause the user to position their face and enable the image capture. In this example, a default projection angle may be associated with the face image, such as ninety degrees. In another technique, rendering module 124 may automatically capture a face image of the viewer and process the image to determine an initial projection angle based on the captured image. For example, the alignment of ears and eyes in the image may be detected and used to establish the initial projection angle.

When the initial face position has been determined, the camera may then be used to detect movements of the viewer's face left and right, up and down and so forth. In particular, projection angles are calculated for graphics rendering based upon the tracked movement (block 404). Then, a graphic presentation is output via the device according to the calculated projection angles (block 406).

For example, rendering module 124 may use face image data obtained via the camera to adjust a 3D object that is displayed when the media content 112 is rendered. The face image data may be used to compute projection angles relative to an initial angle determined through a captured face image as described above. For instance, a captured face image may be processed by the rendering module 124 to ascertain or approximate an angle at which the viewer is viewing the display device 104. A projection plane for presenting the graphic may be derived from the computed projection angles. For instance, when the viewer moves their face around the display device 104, rendering module 124 may detect the difference between a current face position and the initial face position. These detected changes in face position may be used, alone or in conjunction with data from other tracking sensors, as a basis for adjusting rendering of the media content 112.

Referring again to the examples of FIGS. 3A and 3B, consider a movement of a face of the viewer 302 from left to right relative to the client device 102. This face movement may be detected by way of a camera of the device 102. This in turn may cause the left side house image 306 depicted in FIG. 3A to rotate until the right side house image 312 of FIG. 3B is depicted. Similarly, movement of the viewer's face back to left may cause the image to adjust until the left side house image 306 is again depicted. Somewhere in the middle of the viewer's face movement, a frontal view of the house may be rendered. In this manner, tracking data collected by way of a camera of a client device 102 may be used to implement aspects of display surface tracking described herein.

In some situations more than one viewer may view a presentation on a client device 102. To handle these situations, the rendering module 124 may be configured to select a viewer to track from among multiple viewers. A variety of techniques may be employed to select a viewer. For example, the camera and/or other tracking sensors 114 may be used to determine and select a viewer based upon how close different viewers are to the display device 104. In this example a viewer that is closest to the display device 104 may be selected. In another example, a viewer that is located nearest to the center of the display may be determined. For instance, projection angles to each viewer may be determined and the viewer associated with a projection angle closest to zero (or some other configurable value) may be selected for the purposes of tracking. Alternatively, when multiple viewers are detected, rendering module 124 may output a viewer prompt to request a selection of one of the viewers. Tracking may then occur on the basis of input provided to select a viewer in response to the prompt.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
outputting graphics at a device using a projection plane determined based on a viewer's face position, the viewer's face position detected using a camera of the device;
detecting, using the camera, a change in the viewer's face position;
calculating an updated projection plane based on the detected change; and
outputting the graphics at the device using the updated projection plane.

2. The method as recited in claim 1, wherein the projection plane is defined by one or more projection angles, the projection angles derived from the viewer's face position.

3. The method as recited in claim 1, wherein outputting the graphics using the updated projection plane comprises rendering the graphics to maintain the same perspective before and after the change in the viewer's face position.

4. The method as recited in claim 1, wherein the graphics include three-dimensional graphics (3D).

5. The method as recited in claim 4, wherein the projection plane defines which surfaces of the three-dimensional (3D) graphics are visible when the three-dimensional (3D) graphics are output.

6. The method as recited in claim 1, wherein the viewer's face position comprises a position of the viewer's face relative to a display of the device.

7. The method as recited in claim 1, wherein the detecting further comprises capturing a facial image of the viewer's face.

8. The method as recited in claim 1, wherein the detecting and calculating occur responsive to manual manipulation of the device by the viewer.

9. The method as recited in claim 1, wherein the detecting and calculating occur responsive to movement of the viewer's face relative to the device.

10. The method as recited in claim 1, wherein the device is configured as a mobile phone.

11. The method as recited in claim 1, wherein the device is configured as a mobile client device.

12. One or more computer-readable storage media comprising executable instructions that are stored thereon and executable via a processor of a mobile client device to output three-dimensional (3D) graphics at the mobile client device using a projection plane determined based on data obtained from multiple tracking sensors configured to track a position of a display of the mobile client device relative to a viewer.

13. One or more computer-readable storage media as recited in claim 12, wherein the multiple tracking sensors include a camera configured to detect a position of the viewer.

14. One or more computer-readable storage media as recited in claim 12, wherein the instructions are further executable to:
detect changes in the position of a display of the mobile client device relative to the viewer; and
responsive to each detected change in position, calculate a corresponding projection plane used to output the three-dimensional (3D) graphics.

15. A mobile client device comprising:
one or more processors;
memory;
a display device;
one or more tracking sensors including a camera; and
one or more modules stored in the memory and executable via the processor to:
determine an initial position of a viewer of the display device;
present three-dimensional (3D) graphics via the display device using a projection plane computed based on the initial position;
obtain data from the one or more tracking sensors regarding a position of the display device to detect a change in the initial position of the viewer relative to the display device; and
when a change in the initial position is detected:
calculate an updated projection plane based on the change; and
output the three-dimensional (3D) graphics via the display device using the updated projection plane.

16. The mobile client device as recited in claim 15, wherein the initial position is determined based on data obtained via the camera.

17. The mobile client device as recited in claim 16, wherein determining the initial position based on data obtained via the camera comprises:
capturing an image of a face of the viewer; and
processing the captured image to determine an angle at which the viewer is viewing the display device.

18. The mobile client device as recited in claim 15, wherein the initial position is set to a default position for the viewer.

19. The mobile client device as recited in claim 15, wherein to calculate an updated projection plane comprises determining one or more projection angles based on the change in the initial position of the viewer relative to the display device.

20. The mobile client device as recited in claim 15, wherein the tracking sensors further include an accelerometer, a gyroscope, and a distance sensor.
